(19) United States
(12) Patent Application Publication
(10) Pub. No.: US 2025/0313131 A1
(43) Pub. Date: Oct. 9, 2025

(54) SEAT ASSEMBLY SENSORS AND CONTROLS

(71) Applicant: Universal City Studios LLC, Universal City, CA (US)

(72) Inventors: Francis Tam, Orlando, FL (US); Amanda Kate Zielkowski, Orlando, FL (US); Byron Thomas Osborn, Tavares, FL (US); Rebecca Barbara Dean, Orlando, FL (US); Kyle Andrew Dembinski, Orlando, FL (US)

(21) Appl. No.: 19/169,855

(22) Filed: Apr. 3, 2025

Related U.S. Application Data
(60) Provisional application No. 63/574,682, filed on Apr. 4, 2024.

(51) Int. Cl. B60N 2/00

(52) U.S. Cl. CPC B60N 2/0027; B60N 2/0034; B60N 2/0035; B60N 2210/40

(57) ABSTRACT

A system includes a seat configured to receive a passenger, a sensor system configured to detect passenger characteristics including one or more forces or pressures of the passenger against the seat and a contact area of the passenger across the seat, memory circuitry storing instructions thereon, and processing circuitry. The instructions, when executed by the processing circuitry, are configured to cause the processing circuitry to receive the passenger characteristics from the sensor system, and perform an action based on the passenger characteristics.

### CROSS-REFERENCE TO RELATED APPLICATION

This application claims priority to and benefit of U.S. Provisional Application No. 63/574,682, entitled “SEAT ASSEMBLY SENSORS AND CONTROLS,” filed Apr. 4, 2024, which is hereby incorporated by reference in its entirety for all purposes.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Entertainment venues, such as theme or amusement parks, have been created to provide guests with various immersive experiences. These entertainment venues may include various attractions, such as rides (e.g., rollercoasters), shows, games, and the like, some of which employing a ride assembly configured to move guest(s) along a ride path (e.g., track), show effects configured to enhance the immersive experiences of the guest(s), etc.

In certain attractions, such as a ride system, a seat assembly is configured to receive a passenger and includes one or more restraints configured to maintain a position of the passenger within the seat. Unfortunately, traditional mechanisms may not be adequately adaptable to passengers of varying sizes. Additionally or alternatively, traditional mechanisms may require manual actuation and/or adjustment to the one or more restraints by the passenger, an operator or attendant, or both, which can be inefficient (e.g., time-consuming). Accordingly, it is now recognized improved systems and methods that are more efficient and/or precise are desired.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from embodiments set forth below.

In an embodiment, a system includes a seat configured to receive a passenger, a sensor system configured to detect passenger characteristics (including one or more forces or pressures of the passenger against the seat and a contact area of the passenger across the seat), memory circuitry storing instructions thereon, and processing circuitry. The instructions, when executed by the processing circuitry, are configured to cause the processing circuitry to receive the passenger characteristics from the sensor system, and perform an action based on the passenger characteristics.

In an embodiment, one or more non-transitory, computer readable media, stores instructions thereon. When executed by a processing system having one or more processors, the instructions stored in the non-transitory, computer readable media are configured to cause the processing system to perform various actions. The actions include determining (based on sensor feedback from a sensor system including a plurality of sensors) passenger characteristics, receiving restraint data indicative of a status of a restraint corresponding to the seat, determining (based on the passenger characteristics and the restraint data) a recommended adjustment to the restraint, and transmitting an alert indicative of the recommended adjustment or controlling the restraint based on the recommended adjustment.

In an embodiment, a computer-implemented method detects a first force or pressure of a passenger against a first area of a seat, and detecting a second force or pressure of the passenger against a second area of the seat. A first and second sensor detects the force or pressure of the passenger against the first and second area of the seat, respectively. The computer-implemented method also receives, via a processing system having one or more processors, sensor feedback from the first sensor and the second sensor. The computer-implemented method also determines a contact area of the passenger across the seat, and receives, via the processing system, restraint data indicative of a status of a restraint corresponding to the seat. The computer-implemented method also determines, via the processing system, a recommended adjustment to the restraint based on the restraint data and based on the sensor feedback, the contact area, or both.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating various aspects of an attraction, in accordance with an aspect of the present disclosure;

FIG. 2 is a schematic front perspective view of a seat assembly employed in an attraction, in accordance with an aspect of the present disclosure;

FIG. 3 is a schematic front perspective view of a seat assembly of an attraction, in accordance with an aspect of the present disclosure;

FIG. 4 is a schematic front perspective view of a seat assembly of an attraction, in accordance with an aspect of the present disclosure;

FIG. 5 is a schematic illustration of a heat map corresponding to an active passenger profile, in accordance with an aspect of the present disclosure;

FIG. 6 is a process flow diagram corresponding to a method of operating an attraction, in accordance with an aspect of the present disclosure;

FIG. 7 is a process flow diagram corresponding to a method of operating an attraction, in accordance with an aspect of the present disclosure;

FIG. 8 is a schematic side view of a seat assembly employed in an, in accordance with an aspect of the present disclosure;

FIG. 9 is a schematic perspective view of a seat assembly employed in an attraction, in accordance with an aspect of the present disclosure;

FIG. 10 is a block diagram illustrating various aspects of an attraction, in accordance with an aspect of the present disclosure; and

FIG. 11 is a block diagram of various actuatable devices, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to a seat assembly of an attraction (e.g., ride system). More particularly, the present disclosure relates to controlling certain aspects of a seat assembly (e.g., one or more restraints) based on sensor feedback indicative of certain aspects relating to the seat assembly (e.g., relating to a passenger positioned in the seat assembly).

An attraction, such as a ride system, may include a vehicle, such as a ride vehicle, having one or more seat assemblies disposed therein and configured to receive one or more passengers. For example, a seat assembly may include a seat, a seatback (referred to in certain instances of the present disclosure as a backrest support) coupled to or otherwise extending transverse to the seat, and one or more restraints. The passenger may sit in the seat (e.g., upright against the seatback), and the one or more restraints may be controlled to maintain a position of the passenger in the seat, such as a centralized location relative to the seat, the seatback, or both.

In traditional configurations, the restraint(s) may be ill equipped for adaptability to passengers of varying sizes. Additionally or alternatively, the restraint(s) may be manually actuated and/or adjusted, which may be inefficient (e.g., time-consuming). Accordingly, embodiments of the present disclosure may include a sensor system configured to detect various aspects (e.g., characteristics) related to the seat assembly, which enables more efficient and/or more precise restraints, as described in detail below. For example, the sensor system may include a number of sensors (e.g., a first sensor array) distributed across the seat. The sensors may be configured to detect respective forces or pressures (e.g., weight) of the passenger at various locations of the seat, a contact area of the passenger within the seat, or both. In some embodiments, the forces or pressures detected by the sensors (e.g., first sensor array) may be employed to infer the contact area. Certain embodiments may include additional sensors of the sensor system (e.g., a second sensor array) distributed across the seatback and configured to detect additional forces or pressures of the passenger against the seatback and/or an additional contact area of the passenger across the seatback. Still further, in certain embodiments, the sensor system may include one or more restraint sensors configured to detect one or more characteristics of the restraint(s), such as a position of the restraint(s), one or more forces or pressures of the passenger against the restraint(s), a contact area of the passenger against the one or more restraints, etc. Additionally or alternatively, the sensor system may include one or more cameras configured to capture images of the passenger.

A controller assembly (e.g., one or more controllers) may include processing circuitry (e.g., one or more processors) and memory circuitry (e.g., one or more memory), where the memory circuitry (e.g., one or more memory) stores instructions thereon executable by the processing circuitry (e.g., one or more processors). Certain instances of the present disclosure may refer to the one or more processors as a processing system. The controller assembly may be configured to receive sensor feedback from the sensor system and perform an action based on the sensor feedback. For example, the controller assembly may determine a recommended position of the restraint(s) and/or a recommended actuation of the restraint(s) based on the sensor feedback. Further, the controller assembly may be configured to transmit an alert (e.g., to an operator device, a passenger device, a device at the seat assembly) indicative of the recommended position of the restraint(s) and/or the recommended actuation of the restraint(s), automatically adjust the restraint(s) based on the recommended position and/or the recommended actuation, or both.

In some embodiments, the controller assembly may determine the recommended position of the restraint(s) and/or the recommended actuation of the restraint(s) by comparing the sensor feedback, or an active passenger profile derived by way of the sensor feedback, with a number of pre-determined rider baseline profiles. Each pre-determined rider baseline profile may include baseline characteristics corresponding to a particular type (e.g., body type) of passenger. For example, the controller assembly may select a particular rider baseline profile based on a resemblance between the particular rider baseline profile and the sensor feedback (or the active passenger profile derived therefrom). In some embodiments, a bank (e.g., stored in memory) of the various rider baseline profiles may be updated based on the sensor feedback accumulated by the system over time. For example, a new rider baseline profile may be added to the bank, or an existing rider baseline profile may be adjusted in the bank, based on the sensor feedback accumulated over time. In some embodiments, the new rider baseline profile may be added and/or the existing rider baseline profile may be changed based on sensor feedback from the sensor system corresponding to characteristics detected while the attraction is in progress, such as when the ride system is in an operational cycle.

In some embodiments, the active passenger profile may include data indicative of an active passenger heat map (e.g., indicative of forces or pressures and/or contact areas associated with the seat assembly, such as the seat and/or the seatback). Additionally or alternatively, each rider baseline profile may include a respective rider baseline heat map. In this way, the heat map(s) included in the active passenger profile may be compared against the heat map(s) included in each of the rider baseline profiles stored in the bank to select a particular rider baseline profile resembling the active passenger profile. Each rider baseline profile may include a recommended position of the restraint(s) corresponding thereto. Accordingly, in response to identifying a resemblance between the sensor feedback or the active passenger profile thereof (e.g., such as the active passenger heat map or maps) and a particular rider baseline profile (e.g., such as the rider baseline heat map or maps), the controller assembly may be configured to perform and/or recommend rider-specific positions and/or adjustments to the restraint(s) of the seat assembly. The heat map(s) may be referred to as force or pressure map(s) in other areas of the present disclosure. These and other aspects of the present disclosure, described in detail below with reference to the drawings, improve an efficiency, precision, comfort, and/or accuracy of retaining a passenger within a seat assembly via one or more restraint(s).

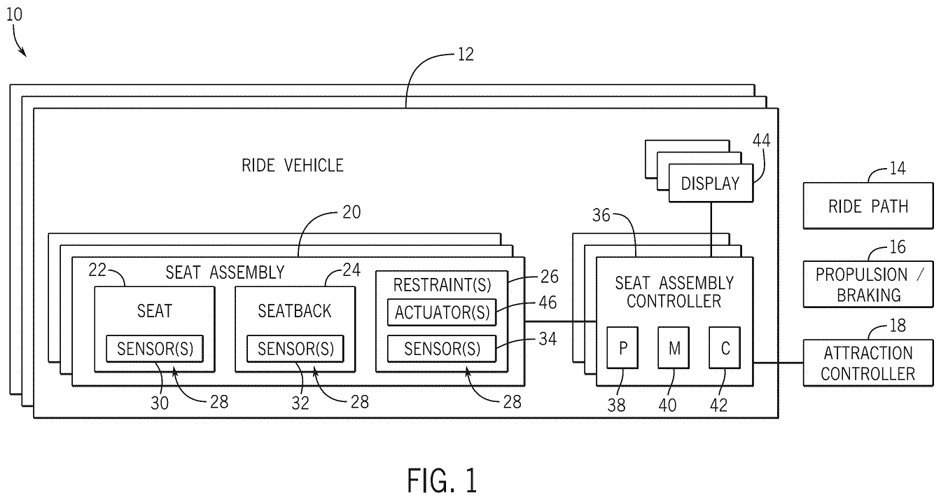

Turning now to the drawings, FIG. 1 is a block diagram illustrating various aspects of an embodiment of an attraction 10 (e.g., ride system). The attraction 10 may include one or more ride vehicles 12, a ride path 14 (e.g., track), a propulsion and/or braking assembly 16 controlled to accelerate and/or decelerate, respectively, the ride vehicle(s) 12 as they move along the ride path 14, and an attraction controller 18 (e.g., a ride system controller including processing circuitry, memory circuitry, and/or communications circuitry) configured to control, for example, the propulsion and braking assembly 16 and other possible componentry of the attraction 10. As described in detail below, embodiments of the present disclosure are directed toward one or more seat assemblies 20 of the one or more ride vehicles 12 and sensor feedback associated with characteristics of the one or more seat assemblies 20 and/or passengers received by the one or more seat assemblies 20.

For example, each seat assembly 20 may include a seat 22 and, in some embodiments, a seatback 24 (e.g., backrest support) coupled to or otherwise corresponding to or extending transverse to the seat 22. The seat assembly 20 may also include one or more restraint(s) 26 (e.g., a lap bar restraint, a shoulder restraint, etc.) configured to maintain a position of a passenger relative to the seat 22 and/or the seatback 24. A sensor system 28 associated with the seat assembly 20 may include seat sensors 30 (e.g., a seat sensor array), seatback sensor 32 (e.g., a seatback or backrest support sensor array), and one or more restraint sensors 34. The seat sensors 30 may be configured to detect one or more characteristics associated with the seat 22, such as forces (e.g., point forces) or pressures of a passenger against the seat 22, a contact area of the passenger across the seat 22, or both. The seatback sensors 32 may be configured to detect one or more characteristics associated with the seatback 24, such as forces (e.g., point forces) or pressures of the passenger against the seatback 24, a contact area of the passenger against the seatback 24, or both. The one or more restraint sensors 34 may be configured to detect one or more characteristics of the one or more restraints 26, such as a position of the restraint(s) 26, a force or pressure of the passenger against the restraint(s) 26, a contact area of the passenger's contact against the restraint(s) 26, a malfunction of the restraint(s) 26, etc.

Other characteristics detected by the seat sensors 30, the seatback sensors 32, and/or the restraint sensor(s) 34 are also possible, such as temperatures corresponding to a presence of a passenger within the seat assembly 20. In some embodiments, the sensor system 28 also may include one or more image sensors (e.g., cameras) configured to capture one or more images of the passenger. A variety of other sensors of the sensor system 28 may be employed in certain embodiments, such as position sensors, orientation sensors, motion detectors etc.

In the illustrated embodiment, the attraction 10 may include one or more seat assembly controllers 36 having processing circuitry 38 (e.g., one or more processors) configured to perform various functions, memory circuitry 40 (e.g., one or more memory) storing instructions thereon and executed by the processing circuitry 38 to perform the various functions, and communications circuitry 42 (e.g., one or more receivers, one or more transmitters, and/or one or more transceivers) enabling wired or wireless communications between the seat assembly controller(s) 36 and other componentry of the attraction 10. The memory circuitry 40 may include random access memory (RAM), read only memory (ROM), rewritable non-volatile memory such as flash memory, hard drives, optical discs, and/or the like. It should be noted that non-transitory merely indicates that the media is tangible and not a signal. The communications circuitry 42 may use any suitable communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof. In some embodiments, each seat assembly 20 may include a respective instance of the seat assembly controller 36. In other embodiments, one instance of the seat assembly controller 36 may be employed for multiple instances of the seat assemblies 20 (e.g., all the seat assemblies 20). For purposes of brevity, the following discussion refers to the seat assembly 20 and the seat assembly controller 36 in the singular, although it should be understood that multiple instances of the seat assembly 20 and/or multiple instances of the seat assembly controller 36 may be employed as discussed above. Further, while the seat assembly controller 36 may be separate from the attraction controller 18 in certain embodiments, a single (e.g., combined) controller may be employed with respect to the attraction 10 generally and the seat assembly 20 specifically in certain embodiments.

In accordance with the present disclosure, the seat assembly controller 36 may be configured to receive sensor feedback from any or all of the sensors (e.g., the seat sensors 30, the seatback sensors 32, and/or the one or more restraint sensors 34) of the sensor system 28. Further, the seat assembly controller 36 may be configured to determine, based on the sensor feedback, a recommended status (e.g., position) of the restraint(s) 26 and/or a recommended adjustment to the restraint(s) 26 based on the sensor feedback.

As an example, the restraint(s) 26 may be adjusted (or recommended to be adjusted) to a first position relatively close to the seat assembly 20 in response to the sensor feedback indicating a relatively small body size, a second at a moderate distance from to the seat assembly 20 in response to the sensor feedback indicating a moderate body size, and a third position relatively far from the seat assembly 20 in response to the sensor feedback indicative a relatively large body size. However, any number of positions are possible. Further, multiple types of restraints 26 (e.g., a lap bar restraint, a shoulder retrain, a shin guard restraint, etc.) may be employed in certain embodiments, and positions of the multiple types of such restraints 26 may be customizable based on the sensor data. For example, in some embodiments, a first type of restraint (e.g., lap bar restraint) may be adjusted to a relatively far position from the seat assembly 20 in response to the sensor data suggesting a relatively large lower body size, and a second type of restraint (e.g., shoulder restraint) may be adjusted to a relatively close position to the seat assembly 20 in response to the sensor data suggesting a relatively small upper body size.

In some embodiments, the seat assembly controller 36 generates and outputs (e.g., via the communications circuitry 42) an alert to a device, such as the attraction controller 18 or some other operator device (e.g., one or more displays 44 at the ride vehicle 12 or elsewhere in the attraction 10), a seat assembly device, a passenger device (e.g., a mobile phone), etc., indicative of the recommended position of the restraint(s) 26 and/or the recommended adjustment to the restraint(s) 26. Additionally or alternatively, in some embodiments, the seat assembly controller 36 controls one or more actuators 46 (e.g., restraint actuators) based on the recommended position of the restraint(s) 26 and/or the recommended adjustment to the restraint(s) 26. In some embodiments, the actuator(s) 46 may also be employed to adjust a position of the seat 22 and/or a position of the seatback 24 based on the sensor feedback.

In general, presently disclosed features illustrated in FIG. 1 and described above may be configured to improve efficiency (e.g., by reducing or negating time-consuming traditional processes) associated with appropriately positioning the restraint(s) 26 relative to the passenger, precision and/or accuracy of such restraint(s) 26 relative to the passenger, comfort of the passenger during a duration or cycle of the attraction 10 (e.g., ride system), etc. More detailed discussion of the sensor feedback and analysis of the sensor feedback by the seat assembly controller(s) 36 is provided with reference to later drawings.

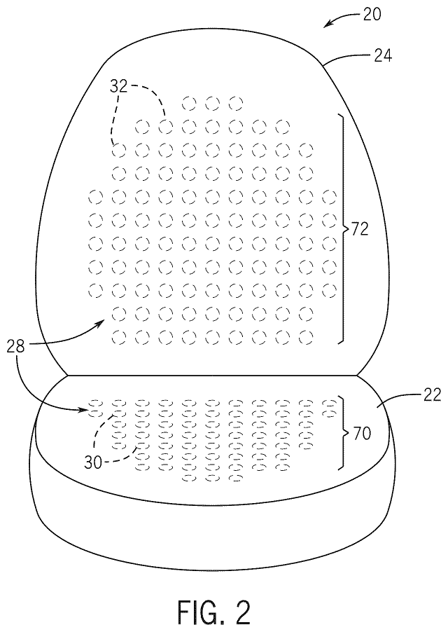

FIG. 2 is a schematic front perspective view of an embodiment of a seat assembly employed in an attraction, such as the seat assembly 20 employed in the attraction 10 of FIG. 1, including the sensor system 28 having sensors distributed throughout the seat assembly 20. As previously described, the sensor system 28 may include seat sensors 30 (e.g., first sensors) distributed through the seat 22 of the seat assembly 20 and/or seatback sensors 32 (e.g., second sensors) distributed through the seatback 24 of the seat assembly 20.

The seat sensors 30, which may include two or more sensors (e.g., 2-500 sensors, 3-400 sensors, 4-300 sensors, 5-200 sensors, 6-100 sensors, or 7-50 sensors), may form a first sensor array 70 (e.g., seat sensor array) corresponding to the seat 22 of the seat assembly 20. The seat sensors 30 may be distributed through the seat 22 in one or more patterns, such as circular patterns, square patterns, rectangular patterns, patterns corresponding to a shape and/or contour of the seat 22, etc. The seatback sensors 32, which may include two or more sensors (e.g., 2-500 sensors, 3-400 sensors, 4-300 sensors, 5-200 sensors, 6-100 sensors, or 7-50 sensors), may form a second sensor array 72 (e.g., seatback or backrest support sensor array) corresponding to the seatback 24 of the seat assembly 20. The sensors of the seatback sensor array 72 may be distributed through the seatback 24 in one or more patterns, such as circular patterns, square patterns, rectangular patterns, patterns corresponding to a shape and/or contour of the seatback 24, etc. While at least some of the sensor system 28 is visible in FIG. 2, it should be understood that all or some of the sensors of the sensor system 28 may not be visible in practice (e.g., hidden under cushioning or other parts of the seat assembly 20).

As previously described, the seat sensors 30 of the seat 22 may be configured to detect forces (e.g., weights, point forces, etc.) or pressures of a passenger against the seat 22 and/or a contact area of the passenger across the seat 22. In some embodiments, the contact area may be derived from the forces or pressures detected by the seat sensors 30. Likewise, the seatback sensors 32 of the seatback 24 may be configured to detect forces (e.g., weights, point forces, etc.) or pressures of the passenger against the seatback 24 and/or a contact area of the passenger across the seatback 24. Although not shown in FIG. 2, it should be understood that the seat assembly 20 also may include one or more restraints and, in some embodiments, one or more sensors of the sensor system 28 correspond to the one or more restraints of the seat assembly 20.

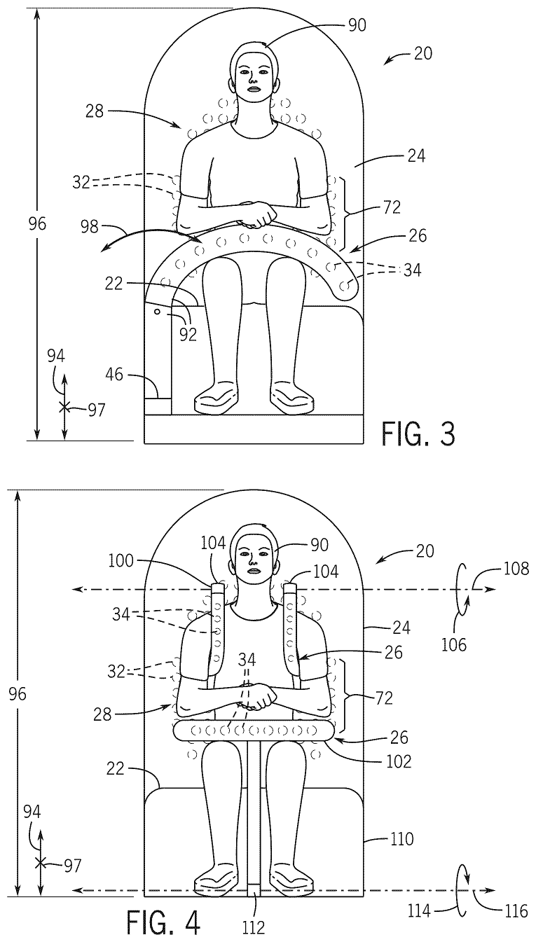

For example, FIG. 3 is a schematic front perspective view of an embodiment of a seat assembly of an attraction, such as the seat assembly 20 employed in the attraction 10 of FIG. 1, including one or more restraints 26 maintaining a position of a passenger 90 relative to the seat 22 of the seat assembly 20 and/or the seatback 24 of the seat assembly 20. In the illustrated embodiment, the one or more restraints 26 may include a translatable (e.g., horizontally actuatable) lap bar restraint 92, referred to as “the lap bar restraint 92” with reference to FIG. 3 for brevity. The lap bar restraint 92 may be actuatable (e.g., via the one or more actuators 46) in a height direction 94 (e.g., parallel to a height dimension 96 of the seat assembly 20), a depth direction 97 transverse to the height direction 94, a width direction 98, or any combination thereof. In some embodiments, actuation of the lap bar restraint 92 in at least one of the directions 94, 97, 98, such as the width direction 98, may be curved or arcuate (e.g., taking a curved or arcuate path). As previously described, the one or more restraints 26, such as the lap bar restraint 92 in FIG. 3, may include one or more restraint sensors 34 (e.g., one restraint sensor, two or more restraint sensors) corresponding to the sensor system 28 and configured to detect at least one restraint characteristic, such as one or more restraint position characteristics, forces or pressures of the passenger 90 against the one or more restraints 26 (e.g., against the lap bar restraint 92), etc.

A position of the lap bar restraint 92 (e.g., with respect to any one or more of the directions 94, 97, 98), as previously described, may be adjusted based at least in part on sensor feedback from the sensor system 28. The sensor feedback may include, for example, sensor feedback from the one or more restraint sensors 34, sensor feedback from the one or more seatback sensors 32 corresponding to the seatback sensor array 72, and/or sensor feedback from the seat sensors 30 (not shown due to illustrated perspective) of the seat sensor array 70 (not shown due to illustrated perspective).

Detailed discussion of sensor feedback analysis and corresponding controls will be provided with reference to later drawings. However, it should first be noted that other embodiments of the seat assembly 20 and/or the one or more restraints 26 corresponding thereto are also possible. For example, FIG. 4 is a schematic front perspective view of an embodiment of a seat assembly of an attraction, such as the seat assembly 20 employed in the attraction 10 of FIG. 1, including one or more restraints 26 (e.g., two restraints) maintaining a position of the passenger 90 relative to the seat 22 of the seat assembly 20 and/or the seatback 24 of the seat assembly 20. In the illustrated embodiment, the one or more restraints 26 may include a rotatable shoulder restraint 100 configured to be lowered over shoulders of the passenger 90 and a rotatable lap bar restraint 102 (referred to as “the lap bar restraint 102” with respect to FIG. 4 for brevity) configured to be raised, for example, between legs of the passenger 90. For example, the rotatable shoulder restraint 100 may be coupled to the seatback 24 at one or more joints 104 and configured to rotate in a circumferential direction 106 about an axis 108 corresponding to the one or more joints 104. The lap bar restraint 102 may be coupled to a portion of the seat assembly 20, such as a base 110 of the seat assembly 20, at one or more additional joints 112 and configured to rotate in an additional circumferential direction 114 about an additional axis 116 corresponding to the one or more additional joints 112.

Still other embodiments of the seat assembly 20 and/or the one or more restraints 26 are also possible. Indeed, it should be understood that the one or more restraints 26 may include a lap bar restraint, a shoulder restraint, a head and/or neck restraint, arm restraints, leg restraints, etc. Further, materials and/or structural characteristics (e.g., rigidity, flexibility, etc.) of the one or more restraints 26 may vary depending on the embodiment. Indeed, certain embodiments may include one or more flexible straps (e.g., extendible and/or retractable flexible straps, the actuation of which may be automated in accordance with aspects of the present disclosure) corresponding to at least a portion of the one or more restraints 26, certain other embodiments may include one or more rigid structures (e.g., bars) corresponding to at least a portion of the one or more restraints 26, and certain other embodiments may include a combination of such flexible straps and rigid structures. The various types of the one or more restraints 26 discussed above with respect to FIGS. 1-4 are merely examples and not limiting on the present disclosure.

As previously described, the sensor system 28 (e.g., of FIG. 1) may be configured to detect various characteristics of the seat assembly 20 (e.g., forces, pressures and/or contact areas associated with a passenger in the seat assembly 20, a restraint status or position associated with the seat assembly 20, etc.) and perform an action (e.g., transmit an alert, control a restraint adjustment actuation, determine a target restraint position or adjustment, etc.) based on the sensor feedback. In some embodiments, in order to determine certain aspects of the action, the seat assembly controller 36 (e.g., of FIG. 1) may be configured to determine or generate an active passenger profile (e.g., based on the sensor feedback) and compare it against pre-determined rider baseline profiles, each pre-determined rider baseline profile corresponding to a respective recommendation for the action(s) performed by the seat assembly controller.

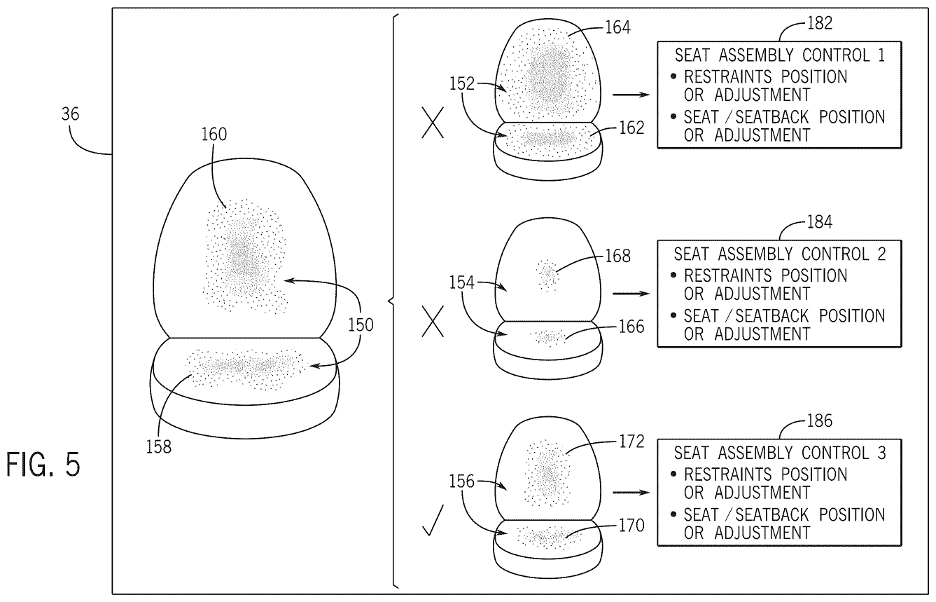

In some embodiments, the active passenger profile may include an active passenger heat map (e.g., generated from the sensor feedback) and each pre-determined rider baseline profile may include a respective rider baseline heat map (noting that the heat map(s) may be referred to as force or pressure map(s) in other areas of the present disclosure). For example, FIG. 5 is a schematic illustration representative or embodiment of a seat assembly controller, such as the seat assembly controller 36 of FIG. 1, comparing an active passenger heat map 150 against rider baseline heat maps 152, 154, 156 corresponding to pre-determined rider baseline profiles. The heat maps 150, 152, 154, 156 may be indicative of, for example, forces or pressures against a seat and/or seatback of a seat assembly, contact area of a passenger against the seat and/or the seatback (or backrest support), etc. An extent of the forces or pressures may be indicated by a shade or color of various areas of the heat map, and a size of the contact area may be indicated by a size of the heat map. As shown, the active passenger heat map 150 may include a seat heat map portion 158, a seatback heat map portion 160, or both. Likewise, the first rider baseline heat map 152 may include a seat heat map portion 162, a seatback heat map portion 164, or both, the second rider baseline heat map 154 may include a seat heat map portion 166, a seatback heat map portion 168, or both, and the third rider baseline heat map 156 may include a seat heat map portion 170, a seatback heat map portion 172, or both.

The seat assembly controller 36 may compare the active passenger heat map 150 against the rider baseline heat maps 152, 154, 156 to determine a resemblance (e.g., resemblance score) between the active passenger heat map 150 and each of the rider baseline heat maps 152, 154, 156. In some embodiments, the seat assembly controller 36 determines first resemblances between the seat heat map portion 158 of the active passenger heat map 150 and each seat heat map portion 162, 166, 170 of each respective rider baseline heat map 152, 154, 156, and second resemblances between the seatback heat map portion 160 of the active passenger heat map 150 and each seatback heat map portion 164, 168, 172 of each respective rider baseline heat map 152, 154, 156, where the seat assembly controller 36 employs the first resemblances and/or the second resemblances to determine which of the rider baseline heat maps 152, 154, 156 most closely corresponds to (e.g., resembles) the active passenger heat map 150. In some embodiments, a first weight may be applied to the first resemblances and a second weight may be applied to the second resemblances in calculating overall resemblances between the active passenger heat map 150 and the ride baseline heat maps 152, 154, 156. Other mathematical principals or steps may also be applied in accordance with the present disclosure. Further, in some embodiments, the heat maps 150, 152, 154, 156 may only include the respective seat heat map portions 158, 162, 166, 170.

Each rider baseline heat map 152, 154, 156 may include respective recommended controls 182, 184, 186 (e.g., including recommended restraint position(s) and/or adjustment(s), recommended seat position(s) and/or adjustment(s), recommended seatback position(s) and/or adjustment(s), etc.). In the illustrated embodiment, the seat assembly controller 36 may determine that the active passenger heat map 150 more closely resembles the third rider baseline heat map 156 than the first rider baseline heat map 152 and the second rider baseline heat map 154. Additionally or alternatively, the seat assembly controller 36 may determine that a resemblance (e.g., resemblance score) between the active passenger heat map 150 and the third rider baseline heat map 156 exceeds a threshold resemblance (e.g., threshold resemblance score), and that resemblances of the active passenger heat map 150 with the first rider baseline heat map 152 and with the second ride baseline heat map 154 does not exceed the threshold resemblance (e.g., threshold resemblance score). In response to identifying the resemblance between the active passenger heat map 150 and the third rider baseline heat map 156, the seat assembly controller 36 may employ the third recommended controls 186 (or actions) corresponding to the third rider baseline heat map 156.

In some embodiments, rider baseline profiles may be updated, changed, or otherwise supplemented over time. For example, heat maps may be updated, changed, or otherwise supplemented over time. The rider baseline profiles may be updated, changed, or otherwise supplemented based on sensor feedback acquired or received by the seat assembly controller 36 over time. In some embodiments, the sensor feedback may be acquired and/or employed during a cycle of the attraction (e.g., ride system). For example, the sensor feedback acquired and/or employed during the cycle of the attraction may inform whether the recommended position(s) of the one or more restraints should be adjusted in a future cycle of the attraction. Other aspects of updating and/or changing rider baseline profiles are described in detail below with reference to later drawings.

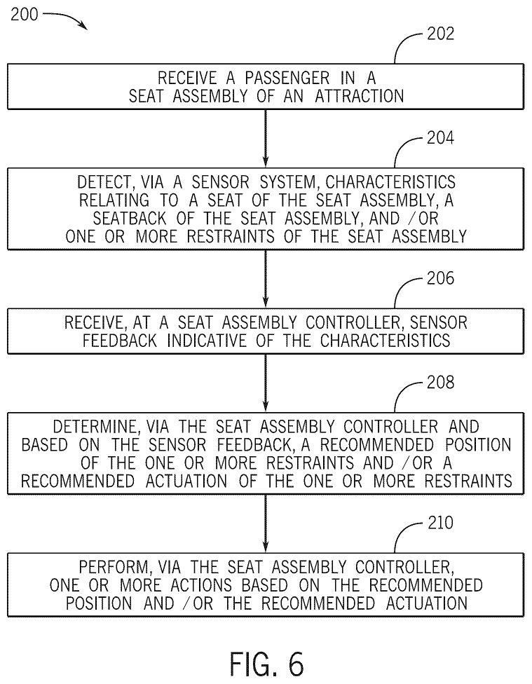

FIG. 6 is a process flow diagram corresponding to an embodiment of a method 200 of operating an attraction, such as the attraction 10 of FIG. 1, including performing an action based on sensor feedback indicative of characteristics of a seat assembly of the attraction. It should be noted that the steps of the method 200 illustrated in FIG. 6 and described in detail below are exemplary and should not be taken to necessarily imply a chronological order of the method 200. While the steps of the method 200 may be performed in the order illustrated in FIG. 6, presently disclosed embodiments may include any suitable ordering and/or chronology of these steps. Further, certain embodiments of the method 200 may include steps other than those illustrated in FIG. 6. Further still, certain steps of the method 200 illustrated in FIG. 6 may be omitted and/or altered in other embodiments.

In the illustrated embodiment, the method 200 may include receiving (block 202) a passenger in a seat assembly of an attraction. For example, the passenger may be seated in a seat of the seat assembly and inclined against a seatback (or backrest support) of the seat assembly. In some embodiments, block 202 also may include engaging one or more restraints, which might be adjusted during later steps of the method 200, while in other embodiments, the one or more restraints remain unengaged. The one or more restraints may include, for example, a lap bar restraint, a shoulder restraint, other types of restraints referenced with respect to earlier drawings, or any combination thereof.

The method 200 also may include detecting (block 204), via a sensor system, characteristics relating to a seat of the seat assembly, a seatback of the seat assembly, and/or one or more restraints of the seat assembly. For example, the characteristics may include forces or pressures of the passenger against the seat and/or the seatback, a contact area of the passenger across the seat and/or the seatback, a status (e.g., position) of the one or more restraints, etc. Other possible characteristics are also possible and referenced with respect to earlier drawings.

The method 200 also may include receiving (block 206), at one or more seat assembly controllers, sensor feedback indicative of the characteristics referenced with respect to block 204 above. The seat assembly controller(s) may be dedicated to a particular seat assembly, divided amongst all the seat assemblies of a ride vehicle or attraction, integrated with one or more attraction controllers, etc.

The method 200 also may include determining (block 208), via the seat assembly controller and based on the sensor feedback, a recommended position of the one or more restraints and/or a recommended actuation of the one or more restraints. For example, the seat assembly controller may determine, based on the sensor feedback, a recommended actuation of the one or more restraints from a current position to a target position (e.g., the recommended position).

The method 200 also may include performing (block 210), via the seat assembly controller, one or more actions based on the recommended position and/or the recommended actuation. For example, the one or more actions may include transmitting an alert (e.g., to a seat assembly device, a passenger device such as a smartphone, an operator or attendant device, etc.) indicative of the recommended position and/or the recommended actuation of the one or more restraints. Additionally or alternatively, the one or more actions may include controlling, via the seat assembly controller, actuation of the one or more restraints based on the recommended position and/or recommended adjustment.

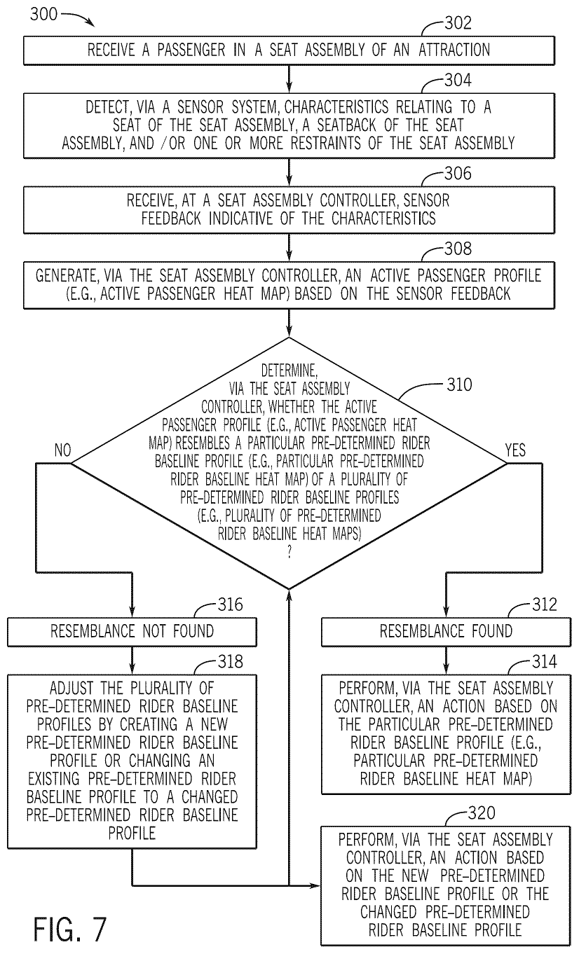

FIG. 7 is a process flow diagram corresponding to an embodiment of a method 300 of operating an attraction, such as the attraction of FIG. 1, including performing an action based on an analysis of an active passenger profile (e.g., active passenger heat map) generated from sensor feedback indicative of characteristics of a seat assembly of the attraction. It should be noted that the steps of the method 300 illustrated in FIG. 7 and described in detail below are exemplary and should not be taken to necessarily imply a chronological order of the method 300. While the steps of the method 300 may be performed in the order illustrated in FIG. 7, presently disclosed embodiments may include any suitable ordering and/or chronology of these steps. Further, certain embodiments of the method 300 may include steps other than those illustrated in FIG. 7. Further still, certain steps of the method 300 illustrated in FIG. 7 may be omitted and/or altered in other embodiments.

In the illustrated embodiment, the method 300 may include receiving (block 302) a passenger in a seat assembly of an attraction. Block 302 of the method 300 of FIG. 7 may be the same as, or similar to, block 202 of the method 200 of FIG. 6. The method 300 also may include detecting (block 304), via a sensor system, characteristics relating to a seat of the seat assembly, a seatback of the seat assembly, and/or one or more restraints of the seat assembly. Block 304 of the method 300 of FIG. 7 may be the same as, or similar to, block 204 of the method 200 of FIG. 6. The method 300 also may include receiving (block 306), at a seat assembly controller, sensor feedback indicative of the characteristics referenced with respect to block 204 above. Block 306 of the method 300 of FIG. 7 may be the same as, or similar to, block 206 of the method 200 of FIG. 6.

The method 300 also may include generating (block 308), via the seat assembly controller and based on the sensor feedback, an active passenger profile (e.g., active passenger heat map) based on the sensor feedback. That is, the active passenger profile may correspond to the passenger currently positioned in the seat assembly. As previously described, the active passenger profile may include one or more active passenger heat maps, such as a first active passenger heat map portion corresponding to the seat of the seat assembly and a second active passenger heat map portion corresponding to the seatback of the seat assembly. The heat map(s) may include different shades or colors indicative of an extent of a force or pressure of the passenger against the seat and/or seatback. Further, a size of the heat map(s) may be indicative of the contact area of the passenger against the seat and/or seatback.

The method 300 also may include determining (decision block 310), via the seat assembly controller, whether the active passenger profile (e.g., active passenger heat map) resembles a particular pre-determined rider baseline profile (e.g., particular pre-determined rider baseline heat map) of a plurality of pre-determined rider baseline profiles (e.g., plurality of pre-determined rider baseline heat maps). For example, a bank of the plurality of pre-determined rider baseline profiles may be stored in memory of the seat assembly controller and/or in a database accessible by the seat assembly controller. Each pre-determined rider baseline profile may correspond to, for example, a body type (e.g., categorized by height, weight, width, other size characteristic, or any combination thereof) or other categorization expected of passengers in the attraction. Each pre-determined rider baseline profile may include a respective pre-determined rider baseline heat map.

In response to a resemblance being found (block 312) by way of decision block 310, the method 300 may include performing (block 314), via the seat assembly controller, one or more actions based on the particular pre-determined rider baseline profile (e.g., particular pre-determined rider baseline heat map). At block 312, the seat assembly controller may calculate resemblance scores between the active passenger profile (e.g., active passenger heat map) and each of the plurality of pre-determined rider baseline profiles (e.g., pre-determined rider baseline heat maps). The seat assembly controller may determine a sufficient resemblance by comparing the scores against a threshold score and/or selecting the highest of the scores, or by considering other criteria related to the active passenger profile and/or the plurality of pre-determined rider baseline profiles. In this way, the seat assembly controller may determine the particular pre-determined rider baseline profile most closely resembling the active passenger profile, and then perform one or more actions based on the determination. For example, the seat assembly controller may determine the particular heat map most closely resembling the active passenger profile, and then perform one or more actions based on the determination.

The action(s) or commands corresponding thereto may be assigned to the particular pre-determined rider baseline profile bearing the resemblance to the active passenger profile. That is, each pre-determined rider baseline profile of the plurality of pre-determined rider baseline profiles may include a respective recommended position of the one or more restraints and/or recommended adjustment to the one or more restraints. For example, the action(s) may include transmitting an alert indicative of a recommended position of one or more restraints corresponding to the seat assembly, a recommended adjustment to the one or more restraints (e.g., from a current position to a target position), or both.

If the decision at decision block 310 results in no resemblance being found (block 316), the method 300 may include adjusting (block 318) (e.g., via the seat assembly controller) the plurality of pre-determined rider baseline profiles by adding a new pre-determined rider baseline profile or changing an existing pre-determined rider baseline profile. If a new pre-determined rider baseline profile is added, a recommended adjustment and/or position of the one or more restraints may be assigned to the new pre-determined rider baseline profile. If an existing pre-determined rider baseline profile is changed, the corresponding recommended adjustment and/or position of the one or more restraints may also be changed. The seat assembly controller may then perform (block 320) an action (e.g., transmit an alert and/or actuate the one or more restraints) based on the new pre-determined rider baseline profile or the changed pre-determined rider baseline profile. Other mechanisms, steps, baselining procedures, etc. for changing and/or developing the plurality of pre-determined rider baseline profiles are possible in accordance with the present disclosure. As an example, in some embodiments, the sensors of the sensor system may detect characteristics (e.g., forces or pressures, contact area, etc.) associated with the seat assembly (e.g., the seat, the seatback, the one or more restraints, etc.) during a cycle of the attraction (e.g., ride system), where the sensor feedback associated with the cycle may be employed to determine whether the one or more restraints were properly positioned and/or to update one or more of the pre-determined rider baseline profiles (e.g., by updating the specified recommendations and/or control actions corresponding thereto).

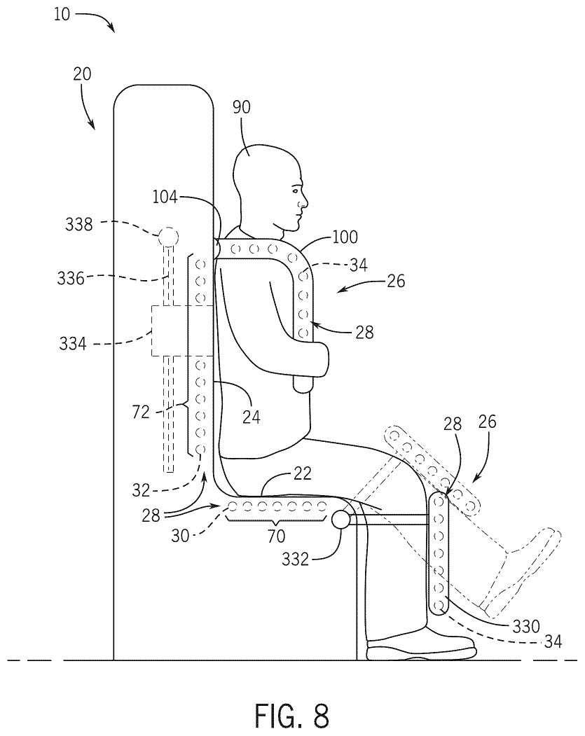

FIG. 8 is a schematic side view of an embodiment of a seat assembly, such as the seat assembly 20 in FIG. 1, employed in an attraction (e.g., ride system), such as the attraction 10 of FIG. 1. The seat assembly 20 in FIG. 8 may include the seat 22 and the seatback 24 extending from the seat 22. The seat assembly 20 also may include the sensor system 28 having the seat sensors 30 (e.g., forming the seat sensor array 70), the seatback sensors 32 (e.g., forming the seatback or backrest support sensor array 72), and the restraint sensors 34.

The sensor system 28 in FIG. 8 may be employed in certain of the same or similar ways as previously described with respect to FIGS. 1-7. For example, sensor data from the sensor system 28 may be employed (e.g., via the seat assembly controller 36 of FIG. 1) to determine initial positions of the one or more restraints 26 (e.g., the shoulder restraint 100 movable about the joint 104, a shin guard restraint 330, etc.) employed in the seat assembly 20 for retaining the passenger 90 therein. Additionally or alternatively, in some embodiments, sensor data from the sensor system 28 may be employed (e.g., via the seat assembly controller 36 of FIG. 1) to determine controls of other aspects of the attraction 10, such as movement of the one or more restraints 26 during a cycle of the attraction 10 (e.g., in response to movement of the passenger 90). For example, the shin guard restraint 330 in the illustrated embodiment, which may include at least one of the restrain sensors 34 therein, may be controllable (e.g., in response to sensor data from the restraint sensor 34 or sensors) about a joint 332 (e.g., motorized joint) to accommodate movement (e.g., bending) of a leg of the passenger 90 during a cycle of the attraction 10. These features may improve a comfort of the passenger 90 in the seat assembly 20 while maintaining a position of the passenger 90 therein.

Additionally or alternatively, sensor data from the sensor system 28 may be employed (e.g., by the seat assembly controller 36 of FIG. 1) to determine controls of immersion features associated with the attraction 10. As an example, sensor data from the seatback sensors 32 may be employed (e.g., by the seat assembly controller 36 of FIG. 1) to control a position of a back massager 334 positioned on a track 336 and movable by an actuator 338 (e.g., motor) communicatively coupled with the seat assembly controller(s) 36 of FIG. 1. That is, the seat assembly controller(s) 36 of FIG. 1 may determine, based on the sensor data, an area of the seatback 24 against which the passenger 90 exerts the greatest force or pressure, and control the position of the back massager 334 to said area. Other immersion features may also be controlled based on the sensor data, such as a foot or back tickler, a water jet, a display configured to output visuals, etc. In some embodiments, the comfort and/or immersion features described above may be coordinated (e.g., physical features may be coordinated with visual features) to enhance a rider experience. In general, the features included in the embodiment of the seat assembly 20 illustrated in FIG. 8 may enable improved immersive experiences and/or comfort of the passenger 90 while maintaining a position of the passenger 90 in the seat assembly 20.

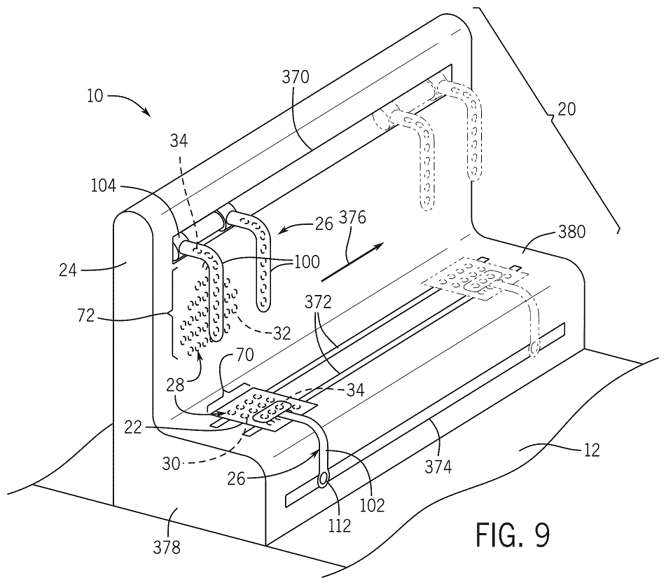

FIG. 9 is a schematic perspective view of an embodiment of a seat assembly, such as the seat assembly 20 of FIG. 1, employed in an attraction (e.g., ride system), such as the attraction 10 of FIG. 1. The seat assembly 20 in FIG. 9 may include the seat 22 and the seatback 24. The seat assembly 20 also may include the sensor system 28 having the seat sensors 30 (e.g., forming the seat sensor array 70), the seatback sensors 32 (e.g., forming the seatback or backrest support sensor array 72), and the restraint sensors 34.

The sensor system 28 in FIG. 9 may be employed in certain of the same or similar ways as previously described with respect to FIGS. 1-8. For example, sensor data from the sensor system 28 may be employed (e.g., via the seat assembly controller 36 of FIG. 1) to determine initial positions of the one or more restraints 26 (e.g., the shoulder restraint 100 movable about the joint 104, the rotatable lap bar restraint 102 movable about the joint 112, etc.) employed in the seat assembly 20 for retaining a passenger (not shown for ease of illustration) therein. Additionally or alternatively, the seat 22 and the restraints 26 (e.g., including the shoulder restraint 100 and the rotatable lap bar restraint 102) may be positioned on a conveyer assembly. For example, the shoulder restraint 100 may be coupled to a first track 370 (e.g., motorized track), the seat 22 may be coupled to one or more second tracks 372 (e.g., motorized tracks), and the rotatable lap bar restraint 102 may be coupled to a third track 374 (e.g., motorized track). Accordingly, the shoulder restraint 100, the seat 22, and the rotatable lap bar restraint 102 may be movable in a direction 376. Because the passenger (not shown) is positioned in the seat 22, the passenger may be moved in the direction 376 along with the seat 22.

Such movement may be performed at various intervals of the attraction 10 (e.g., ride system) to enhance an immersive experience of the passenger (e.g., to position the passenger closer to and/or further away from desired objects, to improve a view of the passenger, etc.). Further, movement of the seat 22 and the restraints 26 may be from a first side 378 of the seat assembly 20 to a second (e.g., opposing) side 380 of the seat assembly 20, or in smaller increments between the first side 378 and the second side 380, depending on the desired effect. Further, such movements may be coordinated with movements of the ride vehicle(s) 12 of the attraction 10 (e.g., to cause a perception that the passenger is moving more quickly than the ride vehicle 12, slower than the ride vehicle 12, in a different direction than the ride vehicle 12, etc.). In some embodiments, such movement (and/or adjustments to the one or more restraints 26 in response to such movement) may be based at least in part on sensor data from the sensor system 28. As an example, a position of the passenger within the seat 22 may be affected by movement of the seat 22 along the track(s) 372. Accordingly, force/pressure characteristics detected by the sensor system 28 may change, justifying changes to the one or more restraints 26 to improve comfort of the passenger, securement of the passenger, etc.

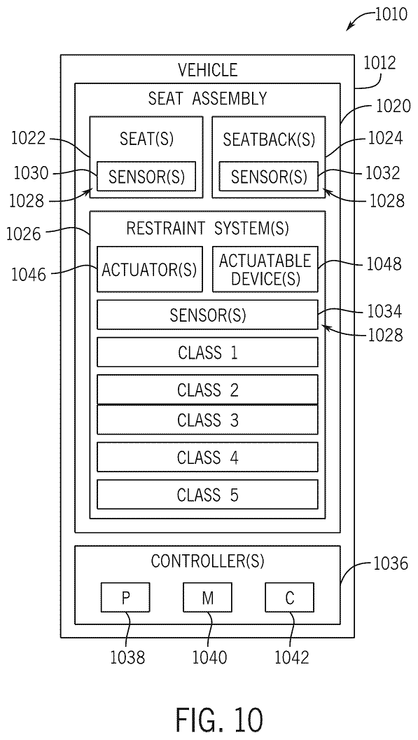

FIG. 10 is a block diagram illustrating various aspects of an embodiment of an attraction 1010, such as a ride system, including a vehicle 1012 (e.g., a ride vehicle) having a seat assembly 1020 with one or more seats 1022 and one or more seatbacks 1024, one or more restraint systems 2026, a sensor system 1028 having various sensors 1030, 1032, 1034 configured to detect various characteristics associated with the seat assembly 1020 and/or the restraint system 1026, and one or more controllers 1036 configured to perform an in-cycle action, such as transiting the restraint system 1026 between a plurality of restraint classes, based on sensor feedback from the sensor system 1028. That is, the sensor system 1028 may be configured to remain active during a cycle of the attraction 1010, and the one or more controllers 1046 may be configured to transition the restraint system 1026 between the plurality of restraint classes during the cycle of the attraction 1010 based on the sensor feedback. In this way, the attraction 1010 may be responsive to transient loads that occur based on movement of the vehicle 1012 during the cycle, as described in greater detail below. Although certain features illustrated in earlier embodiments are not illustrated in FIG. 10, it should be understood that the attraction 1010 may include such features, such as a path or track, a propulsion or braking assembly, additional controllers, multiple instances of the seat assembly 1020 and corresponding features, a display, etc. Further, it should be understood that the control features discussed with respect to FIG. 10 may be employed in combination with or separate from earlier described control features discussed with respect to FIGS. 1-9.

In the illustrated embodiment, the one or more controllers 1036 may include processing circuitry 1038 (e.g., one or more processors), memory circuitry 1040 (e.g., one or more memory) storing instructions thereon executable by the processing circuitry 1038, and communication circuitry 1042 (e.g., one or more receivers, one or more transmitters, and/or one or more transceivers) configured to exchange communications between the controller 1036 and other componentry of the attraction 1010. For example, the controller 1036 may be configured to control various aspects of the restraint system 1026 based on sensor feedback received from the sensor system 1028, such as sensor feedback received from the sensors 1030 corresponding to the seat 1022, sensor feedback received from the sensors 1032 corresponding to the seatback 1024, sensor feedback received from the sensors 1034 corresponding to the restraint system 1026, and/or other sensors associated with the attraction 1010. The sensor feedback described above with respect to the embodiment illustrated in FIG. 10 may be the same as, similar to, or different than sensor feedback described with respect to earlier embodiments (e.g., in FIGS. 1-9).

In an embodiment, the controller 1036 may be configured to actuate, via one or more actuators 1046 corresponding to the restraint system 1026 and based at least in part on the sensor feedback described above, one or more actuatable devices 1048 (e.g., actuatable restraints) of the restraint system 1026. The one or more actuatable devices 1048 may include, for example, a lap bar restraint, a shoulder restraint (including, but not limited to, an over-the-shoulder or OTS restraint), a head and/or neck restraint, a leg restraint, an inflatable restraint, a slidable restraint, a rotatable restraint, a hinged restraint, a pneumatically operated restraint, a hydraulically operated restraint, an electronically operated restraint, a belt restraint, a latching restraint, a locking restraint, etc. In general, the controller 1036 may be configured to instruct in-cycle actions, such as transitions between various classes of the restraint system 1026 during a cycle of the attraction 1010 (e.g., during a ride cycle) in certain embodiments.

For example, the controller 1036 may instruct in-cycle transitions of the restraint system 1026 between a class-1 restraint condition, a class-2 restraint condition, a class-3 restraint condition, a class-4 restraint condition, and/or a class-5 restraint condition. Such transition(s) may be performed in order to comply with regulatory requirements and/or for purposes of providing comfort to the passenger, for example, during different segments, routines, or maneuvers during the cycle (e.g., ride cycle) of the attraction 1010 (e.g., ride system). A class-1 restraint condition may mean, for example, that the passenger is unrestrained (e.g., the passenger can move freely or substantially freely within the vehicle 1012 and/or the seat assembly 1020). A class-2 restraint condition may mean, for example, that a latching restraint is employed to at least partially restrain two or more passengers. For example, when the restraint system 1026 is transitioned to the class-2 restraint condition, multiple passengers may be restrained within their respective seats via a single latching mechanism. A class-3 restraint condition may mean, for example, that latching restraints are employed to at least partially restrain each passenger. For example, when the restraint system 1026 is transitioned to the class-3 restraint condition, each passenger may be restrained via an individual latching mechanism corresponding to their respective seat. A class-4 restraint condition may mean, for example, that a locking restraint is employed to at least partially restrain each passenger. For example, when the restraint system 1026 is transitioned to the class-4 restrain condition, each passenger may be restrained via an individual locking mechanism corresponding to their respective seat. A class-5 restraint condition may mean, for example, that a redundant locking restraint is employed to at least partially restrain each passenger. For example, when the restraint system 1026 is transitioned to the class-5 restraint condition, each passenger may be restrained by a first locking mechanism corresponding to their respective seat and a second (e.g., redundant) locking mechanism corresponding to their respective seat.

Other restraint conditions and transitions of the restraint system 1026 between such other restraint conditions are also possible. For example, in certain embodiments, an inflatable device corresponding to the actuatable devices 1048, such as a g-suit (sometimes referred to as an anti-g suit) or a portion thereof (e.g., the portion corresponding to the legs, torso, arms, head and/or neck, etc. of the respective passenger), may be employed at each of the seats 1022. The inflatable device may be actuated (e.g., inflated) in response to sensor feedback from the sensor system 1028, other sensor feedback (e.g., relating to accelerative forces associated with the vehicle 1012, location-based sensor feedback indicative of a location of the vehicle 1012, user input, etc.), and/or other conditions. In some embodiments, the inflatable device may be employed based at least in part on consent or authorization from the passenger and/or for purposes of passenger comfort (e.g., to improve and/or maintain desirable blood flow during relatively high g-force portions of the attraction 1010). In some embodiments, the inflatable device may be a product offered separately to passengers (e.g., not integrated with the vehicle 1012) and/or with connectivity features (e.g., wireless connectivity features) configured to enable the inflatable device to communicatively couple with the controller 1036.

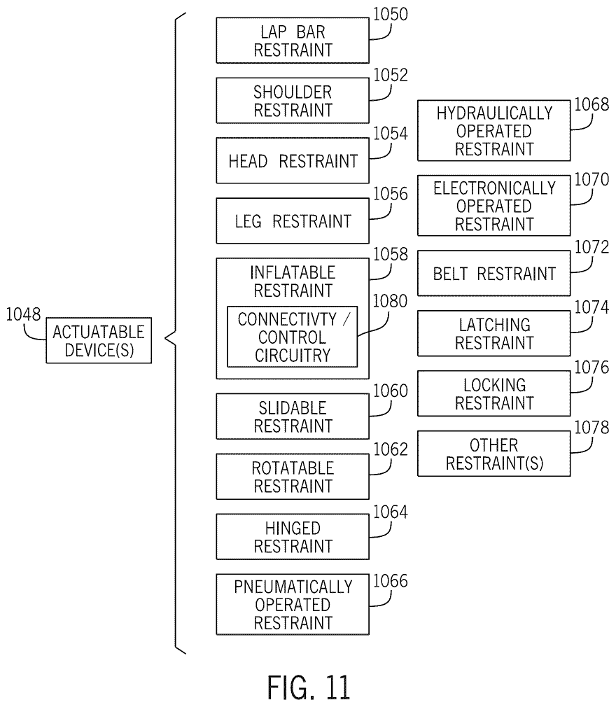

FIG. 11 is a block diagram of various actuatable devices 1048 (e.g., actuatable restraints) that may be employed in the attraction 1010 of FIG. 10. For example, as previously described, the actuatable devices 1048 may include one or more lap bar restraints 1050, one or more shoulder restraints 1052, one or more head and/or neck restraints 1054, one or more leg restraints 1056, one or more inflatable restraints 1058, one or more slidable restraints 1060, one or more rotatable restraints 1062, one or more hinged restraints 1064, one or more pneumatically operated restraints 1066, one or more hydraulically operated restraints 1068, one or more electronically operated restraints 1070, one or more belt restraints 1072, one or more latching restraints 1074, one or more locking restraints 1076, one or more other restraints 1078, and/or any combination thereof. As previously described, in some embodiments, one or more of the actuatable devices 1048 (e.g., restraints) may be provided separate from the attraction 1010 in FIG. 10 (e.g., if desired by particular passengers). As a non-limiting example, the inflatable restraint 1058, which may include a g-suit or portion thereof, may be provided at passenger request. That is, the inflatable restraint 1058 may or may not be integrated with the vehicle 1012 of the attraction 1010 illustrated in FIG. 10. Additionally or alternatively, the inflatable restraint 1058 may include connectivity/control circuitry 1080 configured to enable a communicative coupling (e.g., wireless coupling, wired coupling) with the controller 1036 and/or the sensor system 1028 of the attraction 1010 in FIG. 10, thereby enabling selective activation of the inflatable restraint 1058 in response, for example, to sensor feedback and/or other conditions.

In general, presently disclosed embodiments improve efficiency, accuracy, precision, comfort, and the like associated with actuating and/or engaging one or more restraints of a seat assembly of an attraction to maintain a position of a passenger within the seat assembly. The embodiments illustrated in FIGS. 1-11 are merely examples and non-limiting. Additionally or alternatively, certain aspects illustrated in (and described with respect to) certain specific embodiments of the present disclosure may be implemented in other embodiments of the present disclosure (e.g., to affect the above-described benefits over traditional configurations).

While only certain features have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a seat configured to receive a passenger;
a sensor system configured to detect passenger characteristics including one or more forces or pressures of the passenger against the seat and a contact area of the passenger across the seat;
memory circuitry storing instructions thereon; and
processing circuitry, wherein the instructions, when executed by the processing circuitry, are configured to cause the processing circuitry to:
receive the passenger characteristics from the sensor system; and
perform an action based on the passenger characteristics.

2. The system of claim 1, wherein the sensor system is configured to detect one or more restraint characteristics indicative of a status of a restraint corresponding to the seat.

3. The system of claim 2, wherein the instructions, when executed by the processing circuitry, are configured to cause the processing circuitry to:
determine, based on the passenger characteristics and the one or more restraint characteristics, a recommended adjustment to the restraint or a recommended status of the restraint; and
transmit an alert indicative of the recommended adjustment or the recommended status, or actuate the restraint based the recommended adjustment or the recommended status.

4. The system of claim 1, wherein the processing circuitry is configured to generate a heat map of the seat based on the passenger characteristics.

5. The system of claim 1, wherein the sensor system is configured to detect additional passenger characteristics including one or more additional forces or pressures of the passenger against a seatback coupled to the seat and an additional contact area of the passenger across the seatback, and wherein the instructions, when executed by the processing circuitry, are configured to cause the processing circuitry to:
receive the additional passenger characteristics from the sensor system; and
perform the action or an additional action based on the additional passenger characteristics.

6. The system of claim 1, comprising:
a ride path; and
a ride vehicle comprising the seat, wherein the ride vehicle is coupled to the ride path, and configured to travel along the ride path.

7. The system of claim 1, wherein the memory circuitry is configured to store data indicative of a plurality of rider baseline profiles thereon, wherein each rider baseline profile of the plurality of rider baseline profiles includes a respective one or more baseline forces or pressures and a respective baseline contact area, and wherein the instructions, when executed by the processing circuitry, are configured to cause the processing circuitry to:
select, from the plurality of rider baseline profiles, a rider baseline profile based on a resemblance between the rider baseline profile and the passenger characteristics; and
determine the action based on the rider baseline profile.

8. The system of claim 1, wherein the memory circuitry is configured to store data indicative of a plurality of rider baseline profiles thereon, wherein each rider baseline profile of the plurality of rider baseline profiles includes a respective one or more baseline forces or pressures and a respective baseline contact area, and wherein the instructions, when executed by the processing circuitry, are configured to cause the processing circuitry to modify, based on the passenger characteristics, the plurality of rider baseline profiles by:
adding an additional rider baseline profile to the plurality of rider baseline profiles; or
changing an existing rider baseline profile of the plurality of rider baseline profiles.

9. The system of claim 1, wherein the instructions, when executed by the processing circuitry, are configured to cause the processing circuitry to perform the action based on the passenger characteristics by:
transmitting an alert indicative of a recommended adjustment to a restraint corresponding to the seat, a recommended status of the restraint, or both; or
actuating the restraint based on the recommended adjustment, actuating the restraint to achieve the recommended status, or both.

10. The system of claim 1, wherein the sensor system comprises a plurality of sensors distributed across the seat, and each sensor of the plurality of sensors is configured to detect a respective point force of the one or more forces or pressures of the passenger against a respective portion of the seat.

11. One or more non-transitory, computer readable media, storing instructions thereon that, when executed by a processing system comprising one or more processors, are configured to cause the processing system to:
determine, based on sensor feedback from a sensor system comprising a plurality of sensors, passenger characteristics including one or more forces or pressures of a passenger against a seat and a contact area of the passenger across the seat;
receive restraint data indicative of a status of a restraint corresponding to the seat;
determine, based on the passenger characteristics and the restraint data, a recommended adjustment to the restraint; and
transmit an alert indicative of the recommended adjustment or control the restraint based on the recommended adjustment.

12. The one or more non-transitory, computer readable media of claim 11, wherein the instructions, when executed by the processing system, are configured to cause the processing system to receive the restraint data from the sensor system.

13. The one or more non-transitory, computer readable media of claim 11, wherein the status of the restraint includes a position of the restraint, an additional one or more forces or pressures between the passenger and the restraint, or both.

14. The one or more non-transitory, computer readable media of claim 11, wherein the instructions, when executed by the processing system, are configured to cause the processing system to:
determine, based on sensor feedback, additional passenger characteristics including an additional one or more forces or pressures of the passenger against a seatback coupled to the seat and a contact area of the passenger across the seatback; and
determine, based on the additional passenger characteristics, the recommended adjustment to the restraint.

15. The one or more non-transitory, computer readable media of claim 11, wherein the instructions, when executed by the processing system, are configured to cause the processing system to:
select, from a plurality of rider baseline profiles, a rider baseline profile based on a resemblance between the rider baseline profile and the passenger characteristics, wherein each rider baseline profile of the plurality of rider baseline profiles includes a respective one or more baseline forces or pressures and a respective baseline contact area; and
determine, based on the rider baseline profile, the recommended adjustment to the restraint.

16. The one or more non-transitory, computer readable media of claim 11, wherein the instructions, when executed by the processing system, are configured to cause the processing system to generate a heat map based on the passenger characteristics.

17. A computer-implemented method, comprising:
detecting, via a first sensor, a first force or pressure of passenger against a first area of a seat;
detecting, via a second sensor, a second force or pressure of the passenger against a second area of the seat;
receiving, via a processing system comprising one or more processors, sensor feedback from the first sensor and the second sensor;
determining a contact area of the passenger across the seat;
receiving, via the processing system, restraint data indicative of a status of a restraint corresponding to the seat; and
determining, via the processing system, a recommended adjustment to the restraint based on the restraint data and based on the sensor feedback, the contact area, or both.

18. The computer-implemented method of claim 17, comprising:
transmitting, via the processing system, an alert indicative of the recommended adjustment; or
actuating, via the processing system, the restraint based on the recommended adjustment.

19. The computer-implemented method of claim 17, comprising:
selecting, via the processing system and from a plurality of rider baseline profiles, a rider baseline profile based on a resemblance between the rider baseline profile and the sensor feedback, the contact area, or both; and
determining, via the processing system and based on the rider baseline profile, the recommended adjustment to the restraint.

20. The computer-implemented method of claim 17, comprising determining the contact area of the passenger across the seat based on the sensor feedback.
